(19) United States
(12) Patent Application Publication
(10) Pub. No.: US 2024/0329340 A1
(43) Pub. Date: Oct. 3, 2024

(54) OPTICAL DEVICE

(71) Applicant: TDK CORPORATION, Tokyo (JP)

(72) Inventors: Kenji NAGASE, Hong Kong (CN); Hiroshi TAKE, Hong Kong (CN); Shuntaro KODAMA, Hong Kong (CN); Ryohei FUKUZAKI, Hong Kong (CN)

(73) Assignee: TDK CORPORATION, Tokyo (JP)

(21) Appl. No.: 18/619,829

(22) Filed: Mar. 28, 2024

(30) Foreign Application Priority Data
Mar. 30, 2023 (CN) 202310333094.3

(51) Int. Cl. G02B 6/42

(52) U.S. Cl. CPC G02B 6/4239

(57) ABSTRACT

An optical device includes: a substrate having a pair of main surfaces opposite each other in a first direction, end surfaces adjacent to the main surfaces, and a pair of side surfaces, and an optical waveguide, disposed along the main surface of the substrate and having a light incidence end or a light exit end in the direction of a plane where the end surface is located, wherein, an adhesive for connection is coated on the end surface of the substrate, and at least one stepped portion is formed between the optical waveguide and the adhesive.

### FIELD OF THE INVENTION

The present invention relates to an optical device.

### BACKGROUND OF THE INVENTION

In recent years, with the popularity of fiber optic transmission, the technologies of integrating multiple optical elements with a high density are required. A quartz-based Planar Lightwave Circuit (hereinafter also referred to as PLC) is known as one of the technologies. The quartz-based PLC has excellent characteristics such as a low loss, high reliability, and a high degree of design freedom, and is expected to be a platform with integrated composite functions

In practice, light receiving apparatuses in a transmit end station, an optical module composed of a light receiving element such as a photodiode (hereinafter also referred to as PD), or a light emitting element such as a laser diode (hereinafter also referred to as LD) is mounted by optical coupling with a PLC provided with functional elements such as a duplexer, a branch coupler, and an optical modulator. Moreover, for example, a plurality of LDs and PDs are integrally mounted in a node apparatus of a wavelength division multiplexing transmission mode to monitor the light intensity of a plurality of optical waveguides in the PLC.

However, expensive mounting devices such as chip bonders are required to configure each chip with a good yield, thus it is a problem to realize a low-cost manufacturing process. Additionally, it is also a problem that multiple reworks are required in a case where adhesives contact with light incident/exit ends. Additionally, the adhesive, as a material susceptible to heat, may lead to poor light transmission if the heat from the adhesive affects optical waveguides.

### CITATION LIST

### Patent Document

Patent Document 1: JP 2016-001289

### SUMMARY OF THE INVENTION

The present invention is implemented in light of the above problems, and is intended to provide an optical device which can reduce the risk that adhesives contact with the light incident/exit end of optical waveguides and thereby suppress poor light transmission.

One embodiment of the present invention provides an optical device, comprising: a substrate having a pair of main surfaces opposite each other in a first direction, an end surface adjacent to the main surfaces, and a pair of side surfaces, and an optical waveguide disposed along the main surfaces of the substrate and having a light incidence end or a light exit end in a direction of a plane where the end surface is located, wherein, an adhesive for connection is coated on the end surface of the substrate, and at least one stepped portion is formed between the optical waveguide and the adhesive.

According to the optical device of the present invention, since the stepped portion is formed between the optical waveguide and the adhesive, it is possible to reduce the risk that the adhesive contacts with the light incidence/exit end of the optical waveguide, and it is possible to suppress heat conduction from the adhesive to the optical waveguide by the stepped portion and thereby suppress poor light transmission.

Also, in the optical device of the present invention, preferably, the stepped portion comprises: a first stepped portion formed at the end surface of the substrate in a manner that one end is close to one of the side surfaces of the substrate and the other end is close to the other one of the side surfaces of the substrate.

Also, in the optical device of the present invention, preferably, the stepped portion further comprises: a second stepped portion formed at the end surface of the substrate, having a depth different from that of the first stepped portion, and formed around the optical waveguide in a manner of being spaced apart from the optical waveguide.

Also, in the optical device of the present invention, preferably, the depth of the second stepped portion is greater than the depth of the first stepped portion.

Also, in the optical device of the present invention, preferably, the stepped portion further comprises: a third stepped portion formed at the end surface of the substrate, having a depth different from that of the first stepped portion, and formed around the optical waveguide in a manner of being spaced apart from the optical waveguide, and the optical waveguide is clamped between the second stepped portion and the third stepped portion when viewed from the first direction.

Also, in the optical device of the present invention, preferably, the depth of the third stepped portion is greater than the depth of the first stepped portion. Also, in the optical device of the present invention, preferably, the second stepped portion and/or the third stepped portion are exposed at the main surface of the substrate.

Also, in the optical device of the present invention, preferably, the first stepped portion is interconnected with the second stepped portion and the third stepped portion respectively.

Also, in the optical device of the present invention, preferably, an end portion of the optical waveguide is formed to be closed to an inner side than an end portion of the substrate when viewed from the first direction, and the first stepped portion is exposed at the main surface of the substrate.

Also, the optical device of the present invention preferably further comprises: a protective layer formed adjacent to the optical waveguide, wherein, the second stepped portion and the third stepped portion are further formed at the protective layer.

Also, in the optical device of the present invention, preferably, the first stepped portion, the second stepped portion and the third stepped portion are exposed at the protective layer.

Also, in the optical device of the present invention, preferably, the first stepped portion, the second stepped portion and the third stepped portion are formed in a concave-convex manner with respect to the end surface of the substrate.

Also, in the optical device of the present invention, preferably, the first stepped portion is formed at the end surface of the substrate in a manner substantially parallel to the main surface of the substrate.

### Advantageous Effects of the Invention

The optical device according to the present invention can reduce the risk that the adhesive contacts with the light incident/exit end of the optical waveguide and thereby suppress poor light transmission.

### BRIEF DESCRIPTION OF THE DRAWINGS

FIG. 1 is a perspective view illustrating an optical device 1 according to the first embodiment.

FIG. 2A is a top view illustrating an optical device 1 according to the first embodiment, and FIG. 2B is a front view illustrating an optical device 1 according to the first embodiment.

FIG. 3A is a top view illustrating an optical device 1A according to the second embodiment, and FIG. 3B is a front view illustrating an optical device 1A according to the second embodiment.

FIG. 4A is a top view illustrating an optical device 1B according to the third embodiment, and FIG. 4B is a front view illustrating an optical device 1B according to the third embodiment.

FIG. 5A is a top view illustrating an optical device 1C according to the fourth embodiment, and FIG. 5B is a front view illustrating an optical device 1C according to the fourth embodiment.

FIG. 6A is a top view illustrating an optical device 1D according to the fifth embodiment, and FIG. 6B is a front view illustrating an optical device 1D according to the fifth embodiment.

FIG. 7 is a schematic perspective view illustrating an optical device 1D according to the fifth embodiment in the case of the adhesive overflow.

FIG. 8A is a top view illustrating an optical device 1E according to the sixth embodiment, and FIG. 8B is a front view illustrating an optical device 1E according to the sixth embodiment.

FIG. 9 is an X-Z cross-sectional view illustrating a case in which an optical waveguide of an optical device of an embodiment of the present invention includes a slab portion and a ridge portion.

### DETAILED DESCRIPTION

Hereinafter, the embodiment of the present invention is described in detail with reference to figures. Additionally, the same or equivalent elements are indicated by the same symbols in the figures, and repeated descriptions are omitted.

### First Embodiment

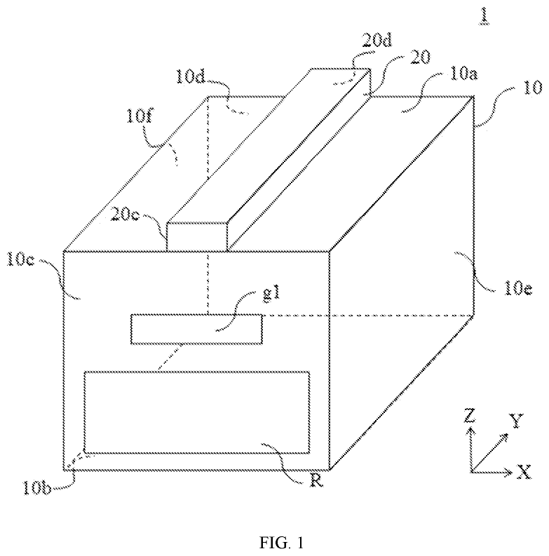

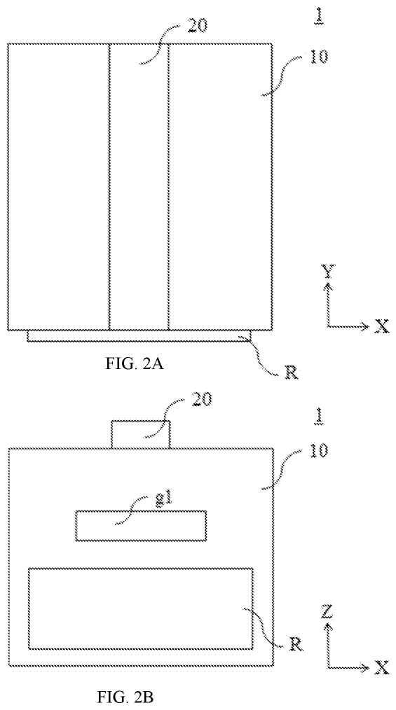

FIG. 1 is a perspective view illustrating an optical device 1 according to the first embodiment. FIG. 2A is a top view illustrating an optical device 1 according to the first embodiment, and FIG. 2B is a front view illustrating an optical device 1 according to the first embodiment.

As shown in FIG. 1, the optical device 1 of the first embodiment comprises a substrate 10, and an optical waveguide 20. An adhesive for connection is coated on an end surface 10c of the substrate 10. At least one stepped portion g1 is formed between the optical waveguide 20 and the adhesive. The optical device 1 may be, for example, a planar lightwave circuit (PLC) used for receiving light signals from light emitting elements such as laser diodes (LD). The adhesive is used to connect the substrate of the planar lightwave circuit (PLC) and the substrate of the laser diode (LD).

Hereafter, each of the substrate 10, the optical waveguide 20, the adhesive, and the stepped portion g1 is described in detail.

### (Substrate)

The substrate 10 has a substantially cuboid shape. The cuboid shape includes a cuboid shape with a chamfered corner and a chamfered edge, and a cuboid shape with a filleted corner and a filleted edge. The substrate 10 has a pair of main surfaces 10a and 10b opposite each other, a pair of end surfaces 10c and 10d opposite each other, and a pair of side surfaces 10e and 10f opposite each other. A direction in which the pair of main surfaces 10a and 10b are opposite each other is a first direction D1 (Z direction). A direction in which the pair of end surfaces 10c and 10d are opposite each other is a second direction D2 (Y direction). A direction in which the pair of side surfaces 10e and 10f are opposite each other is a third direction D3 (X direction). In this embodiment, the first direction D1 is a height direction of the substrate 10. The second direction D2 is a long side direction of the substrate 10, which is orthogonal to the first direction D1. The third direction D3 is a width direction of the substrate 10, which is orthogonal to the first direction D1 and the second direction D2.

The pair of end surfaces 10c and 10d extend in the first direction D1 in a manner of connecting the pair of main surfaces 10a and 10b. The pair of end surfaces 10c and 10d also extend in the third direction D3 (a short side direction of the pair of main surfaces 10a and 10b). The pair of end surfaces 10c and 10d are adjacent to the main surface 10a. The pair of side surfaces 10e and 10f extend in the first direction D1 in a manner of connecting the pair of main surfaces 10a and 10b. The pair of side surfaces 10e and 10f also extend in the second direction D2 (a long side direction of the pair of main surfaces 10a and 10b).

The substrate 10 is not particularly limited as long as it has a lower refractive index than the lithium niobate, but it is preferable a substrate on which a lithium niobate film can be formed as an epitaxial film, and a sapphire single crystal substrate or a silicon single crystal substrate is preferable. The crystal orientation of the single crystal substrate is not particularly limited. The lithium niobate film has properties such as being easily formed as a c-axis-oriented epitaxial film with respect to single crystal substrates of various crystal orientations. Since the c-axis oriented lithium niobate film has three-fold symmetry, it is desirable that the underlying single crystal substrate also has the same symmetry. In the case of a sapphire single crystal substrate, a c-plane substrate is preferred, and in the case of a silicon single crystal substrate, a (111) plane substrate is preferred.

### (Optical Waveguide)

The optical waveguide 20 is disposed along the main surface 10a of the substrate 10 in a manner extending along an XY plane. In the figure, the optical waveguide 20 extends in the second direction D2, and a light transmission direction in the optical waveguide 20 is the same as the second direction D2. However, the optical waveguide 20 may also be disposed in an inclined or meandering manner on the main surface of the substrate 10 as needed. The optical waveguide 20 has a light incidence end 20c at the side of the end surface 10c of the substrate 10, and has a light exit end 20d in the direction of the plane where the end surface 10d is located. It should be understood that the light exit surface 20d may have the same shape as the light incidence surface 20c. The light incident surface 20c receives, for example, light signals from LD. Hereinafter, illustration is made by an example that the optical waveguide 20 has the light incident end 20c at the side of the end surface 10c of the substrate 10.

Since the optical waveguide 20 is not particularly limited as long as it is made of an electro-optic material, the film forming the optical waveguide 20 may be called an electro-optic material film. However, the optical waveguide 20 is preferably composed of lithium niobate (LiNbO₃). This is because lithium niobate has a large electro-optic constant and is suitable as a constituent material of optical devices such as optical modulators. The optical waveguide 20 may also be composed of lithium tantalate (LiTaO₃). In addition, when the optical waveguide 20 is composed of lithium niobate, other elements may also be doped, for example, lithium niobate may be doped with at least one selected from Ti, Mg, Zn, In, Sc, Er, Tm, Yb, and Lu.

The thickness of the lithium niobate film is preferably 2 μm or less, and it is preferably 1.2 μm. This is because if the film thickness is thicker than 2 μm, it is difficult to form a film with high quality. On the other hand, while the film thickness of the lithium niobate film is too thin, the restriction of light in the lithium niobate film becomes weaker and light may leak to the substrate 10. Even if an electric field is applied to the lithium niobate film, there is a concern that the change in the effective refractive index of the optical waveguide 20 becomes smaller. Therefore, the lithium niobate film preferably has a film thickness of about 1/10 or more of the wavelength of the used light. Furthermore, the width of the lithium niobate film may be, for example, 1 μm.

It is desirable to form the lithium niobate film by a film forming method such as sputtering, CVD or sol-gel process. Application of an electric field along the c-axis perpendicular to the main surface of the single-crystal substrate can change the optical refractive index in proportion to the electric field. In the case of the single-crystal substrate made of sapphire, the lithium niobate film can be directly epitaxially grown on the single-crystal sapphire substrate. In the case of the single-crystal substrate made of silicon, the lithium niobate film is epitaxially grown on a clad layer (not shown). The clad layer (not shown) has a lower refractive index than the lithium niobate film and should be suitable for epitaxial growth. For example, a high-quality lithium niobate film can be formed on a clad layer (not shown) made of Y₂O₃.

Here, the epitaxial film is a film oriented in alignment with the crystal orientation of the underlying substrate or underlying film. When the film plane is defined as the XY plane and the film thickness direction is defined as the Z axis, the crystals are aligned and oriented along the X, Y and Z axes. For example, the epitaxial film can be verified by first confirming the intensity at the orientation position by 2θ-θ X-ray diffraction and secondly confirming the pole.

Specifically, first, when measurement is performed by 2θ-θ X-ray diffraction, the peak intensity of all peaks other than the target surface is 10% or less, preferably 5% or less, of the maximum peak intensity of the target surface. For example, in a c-axis oriented epitaxial film of lithium niobate, the peak intensity of planes other than the (00L) plane is 10% or less, preferably 5% or less of the maximum peak intensity of the (00L) plane. (00L) is a generic term for equivalent planes such as (001) and (002).

Secondly, poles must be observed in the measurement. Under the condition where the peak intensities are measured at the first orientation position, only the orientation in a single direction is proved. Even if the first condition is satisfied, in the case of nonuniformity in the in-plane crystalline orientation, the X-ray intensity is not increased at a particular angle, and poles cannot be observed. Since LiNbO₃ has a trigonal crystal system, single-crystal LiNbO₃ (014) has 3 poles. For the lithium niobate film, it is known that crystals rotated by 180° about the c-axis are epitaxially grown in a symmetrically-coupled twin crystal state. In this case, three poles are symmetrically-coupled to form six poles. When the lithium niobate film is formed on a single-crystal silicon substrate having a (100) plane, the substrate has four-fold symmetry, and 4×3=12 poles are observed. In the present invention, the lithium niobate film epitaxially grown in the twin crystal state is also considered to be an epitaxial film.

### (Adhesive)

When other optical apparatuses (e.g., an optical module consisting of light-receiving elements such as photodiodes, or a light-emitting element such as a laser diode, etc.) are bonded to the optical device 1, the end surface 10c may be specified as a bonding surface opposite other optical apparatuses. The optical device 1 is connected to the other optical apparatuses, for example, by an adhesive.

At the end surface 10c of the substrate 10, an adhesive for connection is coated on an adhesive coating region R. The adhesive connects the substrate of LD not shown to the substrate 10 of the optical device 1 of the present invention having an optical waveguide. Connection is performed, for example, by eutectic bonds with other metals. The material of the adhesive includes, for example, one or more metals selected from gold (Au), platinum (Pt), silver (Ag), lead (Pb), indium (In), nickel (Ni), titanium (Ti), tantalum (Ta), tungsten (W), and any alloy selected from alloy AuSn of gold (Au) and tin (Sn), tin (Sn)—silver (Ag)—copper (Cu) based solder alloy (SAC), alloy SnCu of tin (Sn) and copper (Cu), alloy InBi of indium (In) and bismuth (Bi), alloy SnPdAg of tin (Sn)—palladium (Pd)—silver (Ag), alloy SnBiIn of tin (Sn)—bismuth (Bi)—indium (In), and alloy PbBiIn of lead (Pb)—bismuth (Bi)—indium (In).

As a method for forming the adhesive (a metal layer), a well-known method may be utilized, without any special limitation, for example, sputtering, vapor deposition, and coating of a pasted metal.

As an example, first, an Au layer is formed as a first metal layer on a substrate of LD not shown, a SAC layer is formed as a second metal layer on the substrate 10 of the optical device 1 of the present invention, then, alignment is performed in such a manner that the first metal layer and second metal layer overlap, and the substrate is irradiated by a laser to melt the Au layer and SAC layer, so as to bond (integrate) DL to the optical device 1 of the present invention by forming an eutectic layer between the Au layer and SAC layer.

### (Stepped Portion)

When other optical apparatuses are bonded to the end surface 10c of the optical device 1, the adhesive is pressed to overflow from an adhesive coating region R, and a risk that the adhesive contacts with the light incident end 20c of the optical waveguide 20, and heat from the adhesive is conducted to the optical waveguide 20, and thus the optical waveguide 20 has poor light transmission may emerge.

In the optical device 1 of the present embodiment, to reduce the risk described above, at the end surface 10c of the substrate 10, a stepped portion g1 is formed between the optical waveguide 20 and adhesive coating region R, as shown in FIG. 2A. The stepped portion g1 is formed at the end surface 10c of the substrate 10 in a manner that one end is close to one of the side surfaces 10e of the substrate 10 and the other end is close to the other side 10f of the substrate 10. The stepped portion g1 means that there is a height difference between the surface of the stepped portion g1 and the end surface 10 of the substrate 10. Herein, the stepped portion indicates a portion having a height difference (a step difference), and there may be a plurality of height differences (a plurality of step differences) in a stepped portion. The stepped portion g1 is disposed substantially parallel to the main surface 10a of the substrate 10 in a manner that the stepped portion g1 is away from the light incident end 20c of the optical waveguide 20. The stepped portion g1 is formed in a concave-convex manner with respect to the end surface 10c of the substrate 10, for example, by stealth dicing, grinder, laminating, or the like. In FIG. 2B, only a case is shown in which the stepped portion g1 is recessed inward with respect to the end surface 10c of the substrate 10, absolutely, the stepped portion g1 may also be protruded outward with respect to the end surface 10c of the substrate 10. When the stepped portion g1 is recessed inward with respect to the end surface 10c of the substrate 10, the stepped portion g1 can accommodate the adhesive that overflows during bonding, thereby preventing the adhesive from contacting with the light incidence end 20c of the optical waveguide 20. When the stepped portion g1 is protruded outward with respect to the end surface 10c of the substrate 10, the stepped portion g1 can block the adhesive that overflows during bonding, thereby preventing the adhesive from contacting with the light incidence end 20c of the optical waveguide 20.

Thus, since the stepped portion g1 is formed between the optical waveguide 20 and adhesive coating region R, the risk that the adhesive contacts with the light incident/exit end of the optical waveguide can be reduced and thereby poor light transmission is suppressed. Furthermore, the adhesive is a material that is susceptible to be heated. It is desirable that the heat from the adhesive is not conducted to the optical waveguide 20 to maintain a stable temperature for the optical waveguide 20 during operations. The provision of the stepped portion g1 can, on the one hand, keep the adhesive away from the optical waveguide 20 and, on the other hand, increase the heat dissipation surface area of the substrate 10, and thus can prevent the heat of the adhesive from being conducted to the optical waveguide 20, and further suppress poor light transmission.

### Second Embodiment

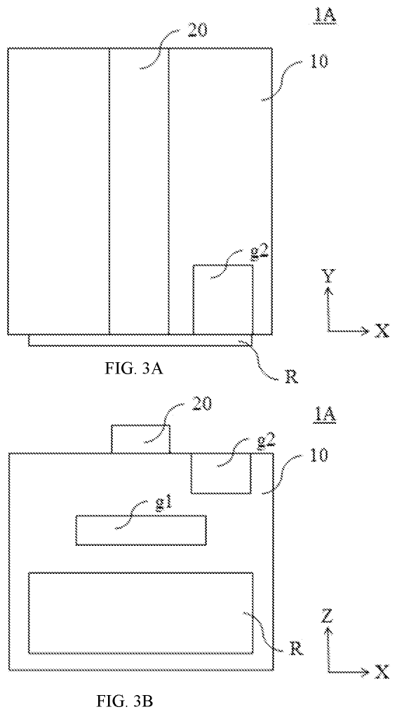

Next, the optical device 1A according to the second embodiment is described. Additionally, in the following embodiments, the same structure as that in the above embodiment is indicated by the same symbols, and repeated descriptions are omitted. FIG. 3A is a top view illustrating an optical device 1A according to the second embodiment, and FIG. 3B is a front view illustrating an optical device 1A according to the second embodiment.

As shown in FIG. 3A, the optical device 1A of the second embodiment differs from the optical device 1 of the first embodiment in that, besides forming a stepped portion g1 at the end surface 10c of the substrate 10, the stepped portion g2 is formed between the optical waveguide 20 and the adhesive coating region R at the end surface 10c of the substrate 10.

As shown in FIG. 3B, the stepped portion g2 is formed around the optical waveguide 20 in a manner of being spaced apart from the optical waveguide 20. The stepped portion g2 is exposed at the main surface 10a of the optical device 1A. The depth (the width in the second direction D2) of the stepped portion g2 is different from the depth of the stepped portion g1, and preferably, the depth of the stepped portion g2 is greater than the depth of the stepped portion g1.

The stepped portion g2 is formed in a concave-convex manner with respect to the end surface 10c of the substrate 10, e.g., by stealth dicing, grinder, laminating, etc., which is same as the stepped portion g1. In FIG. 3B, only a case is shown in which the stepped portion g2 is recessed inward with respect to the end surface 10c of the substrate 10, absolutely, the stepped portion g2 may also be protruded outward with respect to the end surface 10c of the substrate 10. When the stepped portion g2 is recessed inward with respect to the end surface 10c of the substrate 10, the stepped portion g2 can, together with the stepped portion 1, further accommodate the adhesive that overflows during bonding, and thereby prevent the adhesive from contacting with the light incidence end 20c of the optical waveguide 20. When the stepped portion g2 is protruded outward with respect to the end surface 10c of the substrate 10, the stepped portion g2 can, together with the stepped portion 1, further block the adhesive that overflows during bonding and thereby prevent the adhesive from contacting with the light incidence end 20c of the optical waveguide 20.

Since the stepped portion g2 is spaced apart from the optical waveguide 20, the adhesive can be prevented from contacting with the optical waveguide 20. And, by providing the stepped portion g2 with a depth greater than that of the stepped portion g1, the adhesive can be further prevented from contacting with the light incidence end 20c of the optical waveguide 20 when a larger amount of adhesive overflows during bonding.

Thus, the risk that the adhesive contacts with the light incident/exit end of the optical waveguide can be further reduced by forming the stepped portion g2 between the optical waveguide 20 and adhesive coating region R, besides forming the stepped portion g1 between the optical waveguide 20 and adhesive coating region R, and thereby poor light transmission is suppressed. The provision of the stepped portions g1, g2 can, on the one hand, keep the adhesive away from the optical waveguide 20 and, on the other hand, increase the heat dissipation surface area of the substrate 10 and thus can prevent the heat of the adhesive from being conducted to the optical waveguide 20, maintain a stable temperature for the optical waveguide 20 during operations to further suppress poor light transmission.

### Third Embodiment

Next, the optical device 1B of the third embodiment is described. Additionally, in the following embodiment, the same structure as that in the above embodiment is indicated by the same symbols, repeated descriptions are omitted.

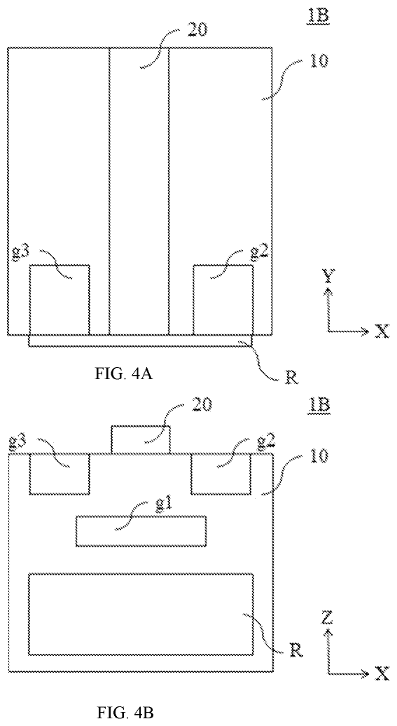

FIG. 4A is a top view illustrating an optical device 1B in the third embodiment, and FIG. 4B is a front view illustrating an optical device 1B in the third embodiment.

As shown in FIG. 4A, the optical device 1B of the third embodiment differs from the optical device 1A of the second embodiment in that, besides forming a stepped portion g1 and a stepped portion g2 at the end surface 10c of the substrate 10, the stepped portion g3 is formed between the optical waveguide 20 and the adhesive coating region R at the end surface 10c of the substrate 10.

As shown in FIG. 4B, the stepped portion g3 is formed around the optical waveguide 20 in a manner of being spaced apart from the optical waveguide 20. When viewed from the first direction D1, the optical waveguide 20 is clamped between the stepped portion g3 and the stepped portion g2. The stepped portion g3 is exposed at the main surface 10a of the optical device 1B. The depth (the width in the second direction D2) of the stepped portion g3 is different from the depth of the stepped portion g1, and preferably, the depth of the stepped portion g3 is greater than the depth of the stepped portion g1. The depth of the stepped portion g3 may be the same as or different from the depth of the stepped portion g2.

The stepped portion g3 is formed in a concave-convex manner with respect to the end surface 10c of the substrate 10, e.g., by stealth dicing, grinder, laminating, etc., which is the same as the stepped portion g1 and the stepped portion g2. In FIG. 4B, only a case is shown in which the stepped portion g3 is recessed inward with respect to the end surface 10c of the substrate 10, absolutely, the stepped portion g3 may also be protruded outward with respect to the end surface 10c of the substrate 10. When the stepped portion g3 is recessed inward with respect to the end surface 10c of the substrate 10, the stepped portion g3 can, together with the stepped portion 1 and the stepped portion 2, further accommodate the adhesive that overflows during bonding and thereby prevent the adhesive from contacting with the light incidence end 20c of the optical waveguide 20. When the stepped portion g3 is protruded outward with respect to the end surface 10c of the substrate 10, the stepped portion g3 can, together with the stepped portion 1 and the stepped portion 2, further block the adhesive that overflows during bonding and thereby prevent the adhesive from contacting with the light incidence end 20c of the optical waveguide 20.

Since the stepped portion g3 is spaced apart from the optical waveguide 20, the adhesive can be prevented from contacting with the optical waveguide 20. And, by providing the stepped portion g3 with a depth greater than that of the stepped portion g1, the adhesive can be further prevented from contacting with the light incidence end 20c of the optical waveguide 20 when a larger amount of adhesive overflows during bonding.

Thus, the risk that the adhesive contacts with the light incident/exit end of the optical waveguide can be further reduced by forming the stepped portion g3 between the optical waveguide 20 and adhesive coating region R, besides forming the stepped portions g1 and g2 between the optical waveguide 20 and adhesive coating region R and thereby poor light transmission is suppressed. The provision of the stepped portions g1˜g3 can, on the one hand, keep the adhesive away from the optical waveguide 20 and, on the other hand, increase the heat dissipation surface area of the substrate 10, and thus can effectively prevent the heat of the adhesive from being conducted to the optical waveguide 20 and thereby maintain a stable temperature for the optical waveguide 20 during operations to further suppress poor light transmission.

### Fourth Embodiment

Next, the optical device 1C in the fourth embodiment is described. Additionally, in the following embodiments, the same structure as that in the above embodiment is indicated by the same symbols, repeated descriptions are omitted.

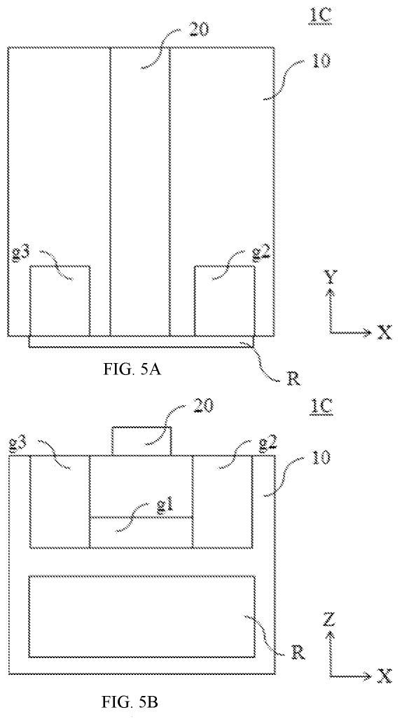

FIG. 5A is a top view illustrating an optical device 1C in the fourth embodiment, and FIG. 5B is a front view illustrating an optical device 1C in the fourth embodiment.

As shown in FIG. 5A, the optical device 1C of the fourth embodiment differs from the optic device 1B in the third embodiment in that, the stepped portion g1 is interconnected with the stepped portions g2 and g3 respectively.

In FIG. 5B, the stepped portion g1 is interconnected with the stepped portions g2 and g3 respectively, and as a whole, they are formed as a substantially U-shaped stepped portion in the X-Z cross-section. For ease of illustration, the dashed line in FIG. 5B indicates a practically invisible line. Since the stepped portion g1 is interconnected with the stepped portion g2 and the stepped portion g3, the stepped portions g1, g2, and g3 can accommodate or block even more adhesive when a relatively large amount of an adhesive overflows during bonding, and can further prevent the adhesive from contacting with the light incident end 20c of the optical waveguide 20.

Thus, by interconnecting the stepped portion g1 with the stepped portion g2 and the stepped portion g3 respectively, the risk that the adhesive contacts with the light incident/exit end of the optical waveguide can be further reduced and thereby poor light transmission is suppressed. The provision of the stepped portions g1˜g3 can, on the one hand, keep the adhesive away from the optical waveguide 20 and, on the other hand, increase the heat dissipation surface area of the substrate 10, and thus can effectively prevent the heat of the adhesive from being conducted to the optical waveguide 20, and maintain a stable temperature for the optical waveguide 20 during operations to further suppress poor light transmission.

### Fifth Embodiment

Next, the optical device 1D in the fifth embodiment is described. Additionally, in the following embodiment, the same structure as that in the above embodiment is indicated by the same symbols, repeated descriptions are omitted.

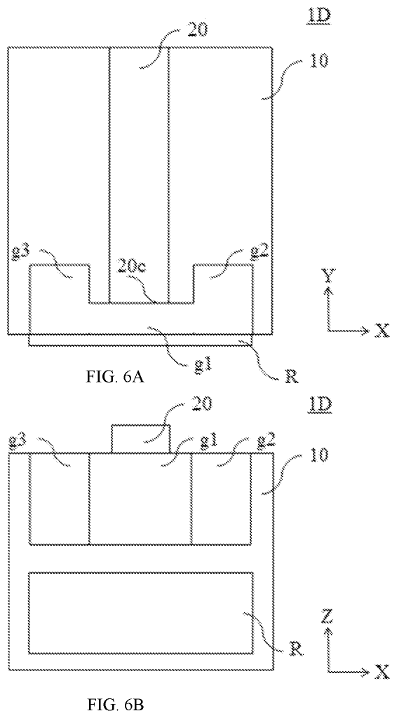

FIG. 6A is a top view illustrating an optical device 1D in the fifth embodiment, and FIG. 6B is a front view illustrating an optical device 1D in the fifth embodiment.

As shown in FIG. 6A, the optical device ID of the fifth embodiment differs from the optical device 1C of the fourth embodiment in that, besides interconnecting the stepped portion g1 with the stepped portion g2 and the stepped portion g3, the end portion of the optical waveguide 20 is closer to an inner side than the end portion of the substrate 10.

When viewed from the first direction D1, the light incident end 20c of the optical waveguide 20 is formed to be closer to the inner side than the end surface 10c of the substrate 10. Moreover, the stepped portion g1 extends in the first direction D1 and is exposed at the main surface 10a of the substrate 10.

Since the light incident end 20c of the optical waveguide 20 is closer to the inner side with respect to the end surface 10c of the substrate 10, an adhesive can be prevented from contacting with the light incident end 20c of the optical waveguide 20.

Moreover, compared with the stepped portion formed as a substantially U-shape in the X-Z cross-section formed by the stepped portions g1, g2, and g3 in the optical device 1C of the fourth embodiment, the stepped portion in the optical device 1D of the present embodiment, which is rectangular in shape in the X-Z cross-section and formed by the stepped portions g1, g2, and g3, has a larger capacity (volume), so that the adhesive can be further prevented from contacting with the light incident end 20c of the optical waveguide 20.

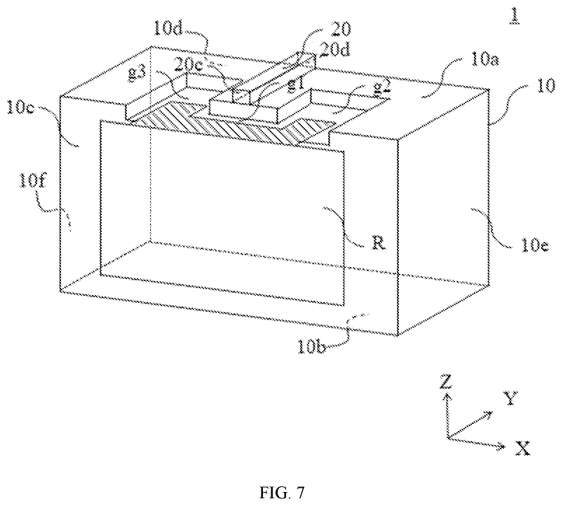

FIG. 7 is a schematic perspective view illustrating an optical device 1D in the fifth embodiment in the case of the adhesive overflow. When the substrate of the LD not shown is bonded to the substrate 10 of the present application, the adhesive coated on the adhesive coating region R may overflow to the surfaces of the stepped portions g1, 92, and g3 that are exposed to the main surface 10a, as shown by the shaded portions of FIG. 7. However, even if the adhesive coated on the adhesive coating region R overflows, it does not contact with the light incidence end 20c of the optical waveguide 20.

Thus, since the end portion of the optical waveguide 20 is closer to the inner side than the end portion of the substrate 10, and the stepped portion g1 is exposed at the main surface 10a of the substrate 10, the risk that the adhesive contacts with the light incident/exit end of the optical waveguide can be further reduced and thereby poor light transmission is suppressed. The light incident end 20c of the optical waveguide 20 is closer to the inner side than the end surface 10c of the substrate 10, and the setting that the stepped portions g1˜g3 is exposed at the main surface 10a of the substrate 10 can, on the one hand, keep the adhesive away from the optical waveguide 20 and, on the other hand, increase the heat dissipation surface area of the substrate 10, and thus can prevent the heat of the adhesive from being conducted to the optical waveguide 20, maintain a stable temperature for the optical waveguide 20 during operations to further suppress poor light transmission.

### Sixth Embodiment

Next, the optical device 1E in the sixth embodiment is described. Additionally, in the following embodiments, the same structure as that in the above embodiment is indicated by the same symbols, and repeated descriptions are omitted.

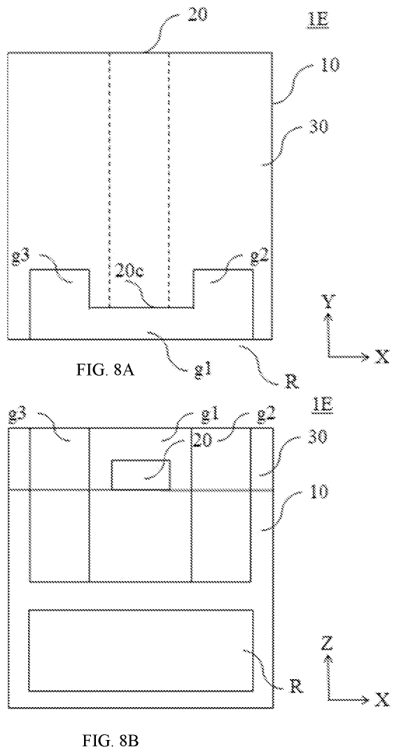

FIG. 8A is a top view illustrating an optical device 1E in the sixth embodiment, and FIG. 8B is a front view illustrating an optical device 1E in the sixth embodiment.

As shown in FIG. 8A, the optical device 1E in the sixth embodiment differs from the optical device 1D in the fifth embodiment in that, the protective layer 30 formed adjacent to the optical waveguide 20, and the stepped portion g2 and the stepped portion g3 formed at the protective layer 30. For ease of illustration, the dashed lines in FIG. 8A and FIG. 8B indicate practically invisible lines.

### (Protective Layer)

The protective layer 30 is formed adjacent to the optical waveguide 20 to prevent light propagating in the optical waveguide 20 from being absorbed by the substrate 10 or an external electrode. In this embodiment, the protective layer 30 covers not only the upper surface of the optical waveguide 20, but also the substrate 10 on which the optical waveguide 20 is not formed, and the side surfaces of the optical waveguide 20 are also covered by the protective layer 30, so that the propagation loss of light in the optical waveguide 20 can be reduced.

The material of the protective layer 30 may be selected widely. For example, the protective layer 30 may be made by a non-metallic oxide such as silicon oxide, a metal oxide such as alumina, a metal nitride, a metal carbide, a resin material such as polyimide, or an insulating material such as a ceramic. The protective layer material may be a crystalline material or an amorphous material. As a more preferred embodiment, for the protective layer 30, a material having a refractive index less than that of the optical waveguide 20 can be used, such as Al₂O₃, SiO₂, LaAlO₃, LaYO₃, ZnO, HfO₂, MgO, Y2O₃, and the like. The protective layer 30 formed on the optical waveguide 20 may have the thickness of about 0.2˜1.2 μm.

As shown in FIG. 8B, the stepped portion g2 and the stepped portion g3 are formed at the protective layer 30 and are exposed at the protective layer 30. Further, the stepped portion g1 may also be formed at the protective layer 30 and exposed at the protective layer 30. In the example shown in FIG. 8B, it is shown that the stepped portions g1, g2, and g3 are formed at the protective layer 30 and are exposed at the protective layer 30, but the stepped portion g1 also may not be formed at the protective layer.

The optical device 1E in the sixth embodiment can further prevent the adhesive from contacting with the light incident end 20c of the optical waveguide 20 by forming the protective layer 30 adjacent to the optical waveguide 20, and forming the stepped portion 92 and the stepped portion g3 at the protective layer 30. Moreover, with the same effect as that of the optical devices 1, 1A˜1D in the first to fifth embodiments, the risk that the adhesive contacts with the light incident/exit end of the optical waveguide can be further reduced and thereby poor light transmission is suppressed. The provision of forming the stepped portions g1˜g3 at the protective layer 30 can, on the one hand, keep the adhesive away from the optical waveguide and, on the other hand, protect the optical waveguide 20 from external stresses or thermal shocks, and thus can prevent the heat of the adhesive from being conducted to the optical waveguide 20 and maintain a stable temperature for the optical waveguide 20 during operations to further suppress poor light transmission

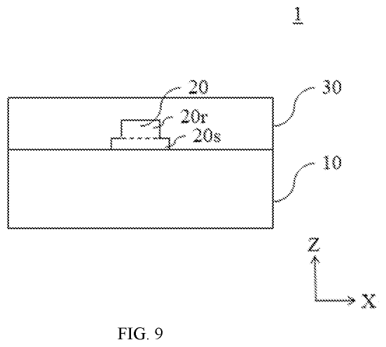

FIG. 9 is an X-Z cross-sectional view illustrating a case in which an optical waveguide of an optical device of an embodiment of the present invention includes a slab portion and a ridge portion.

As shown in FIG. 9, the optical waveguide 20 is composed of the slab portion 20s and the ridge portion 20r protruding from the slab portion 20s. The slab portion 20s is formed on the substrate 10 in a thin form and may be formed, for example, in the shape of a layer or a slab, but not limited to this, and may also be a slightly inclined layer, such as a trapezoidal shape. The ridge portion 20r protrudes from the slab portion 20s, and may for example, protrude upward from the slab portion 20s by a certain height in a columnar shape. However, the shape of the ridge portion 20r is not limited hereby, and may also protrude in a cone shape only, or may further protrude in a plurality of stages. Since light propagates mainly within the 15 ridge portion 20r of the optical waveguide 20, it is preferred that the adhesive at least does not contact with the ridge portion 20r of the optical waveguide 20. Thus, the heat of the adhesive can be prevented from being conducted to the optical waveguide 20, and maintain a stable temperature for the optical waveguide 20 during operations to further suppress poor light transmission.

### Example

The Example was the optical device 1 shown in FIGS. 2A and 2B having the stepped portion g1 formed at the end surface 10c, and the Comparative example was the optical device having the same structure as the optical device 1 shown in FIGS. 2A and 2B, but a stepped portion was not formed at the end surface 10c of the optical device of the Comparative example. The Example and the Comparative example were compared in terms of the defective rate of light transmission. The results are shown in Table 1.

As can be seen from Table 1, by forming the stepped portion g1 at the end surface 10c, the defective rate of light transmission can be suppressed to be less. This is because, by forming the stepped portion g1 between the light waveguide 20 and adhesive coating region R, it is possible to prevent the adhesive from contacting with the light incidence end 20c of the light waveguide 20, so as to reduce the risk that the adhesive contacts with the light incidence/exit end of the light waveguide.

TABLE 1

| | Whether the stepped | |
|---|---|---|
| | portion is formed at the | Defective rate of light |
| | end surface | transmission |
| Example | Yes | <0.1% |
| Comparative example | No | 2% |

Although the present invention is specifically described above in connection with the figures and the examples, it is understood that the above description does not limit the present invention in any form. For example, in the description of the optical devices 1, 1A˜1E described above, an example that one optical waveguide 20 is formed along the substrate 10 is used, but it is not limited thereto, and more than one optical waveguide are also possible.

Also, in the above embodiments, the optical waveguide 20 has a light incidence end 20c at the side of the end surface 10c of the substrate 10, on which the adhesive coating region R is formed, but the optical waveguide 20 may also have a light exit end 20d at the side of the end surface 10c of the substrate 10.

Furthermore, in the above embodiments, examples comprising 1 to 3 stepped portions are recited, but it is not limited thereto. A structure comprising more than 3 stepped portions is also possible. Furthermore, there is no limitation to the size of the stepped portions.

A person skilled in the art could make modifications and changes to the present invention as needed, without deviating from the spirit and scope of the present invention, and these modifications and changes all fall within the scope of the present invention.

### REFERENCE NUMERAL

1. 1A, 1B, 1C, 1D, 1E optical device
10 substrate
10a, 10b main surface
10c, 10d end surface
10e, 10f side surface
20 optical waveguide
20c light incidence end
20d light exit end
R adhesive coating region
g1, g2, g3 stepped portion
30 protective layer
D1 first direction (Z direction)
D2 second direction (Y direction)
D3 third direction (X direction)

1-13. (canceled)

14. An optical device comprising:
a substrate having a pair of main surfaces opposite each other in a first direction, an end surface adjacent to the main surfaces, and a pair of side surfaces, and an optical waveguide disposed along the main surfaces of the substrate and having a light incidence end or a light exit end in a direction of a plane where the end surface is located,
wherein,
an adhesive for connection is coated on the end surface of the substrate, and
at least one stepped portion is formed between the optical waveguide and the adhesive.

15. The optical device according to claim 14, wherein,
the stepped portion comprises: a first stepped portion formed at the end surface of the substrate in a manner that one end is close to one of the side surfaces of the substrate and the other end is close to the other one of the side surfaces of the substrate.

16. The optical device according to claim 15, wherein,
the stepped portion further comprises: a second stepped portion formed at the end surface of the substrate, having a depth different from that of the first stepped portion, and formed around the optical waveguide in a manner of being spaced apart from the optical waveguide.

17. The optical device according to claim 16, wherein,
the depth of the second stepped portion is greater than the depth of the first stepped portion.

18. The optical device according to claim 16, wherein,
the stepped portion further comprises: a third stepped portion formed at the end surface of the substrate, having a depth different from that of the first stepped portion, and formed around the optical waveguide in a manner of being spaced apart from the optical waveguide, and
the optical waveguide is clamped between the second stepped portion and the third stepped portion when viewed from the first direction.

19. The optical device according to claim 18, wherein,
the depth of the third stepped portion is greater than the depth of the first stepped portion.

20. The optical device according to claim 18, wherein,
the second stepped portion and/or the third stepped portion are exposed at the main surface of the substrate.

21. The optical device according to claim 18,
wherein,
the first stepped portion is interconnected with the second stepped portion and the third stepped portion respectively.

22. The optical device according to claim 15, wherein,
an end portion of the optical waveguide is formed to be closer to an inner side than an end portion of the substrate when viewed from the first direction, and
the first stepped portion is exposed at the main surface of the substrate.

23. The optical device according to claim 18, further comprising:
a protective layer formed adjacent to the optical waveguide,
the second stepped portion and the third stepped portion are further formed at the protective layer.

24. The optical device according to claim 23, wherein,
the first stepped portion, the second stepped portion and the third stepped portion are exposed at the protective layer.

25. The optical device according to claim 18, wherein,
the first stepped portion, the second stepped portion and the third stepped portion are formed in a concave-convex manner with respect to the end surface of the substrate.

26. The optical device according to claim 15, wherein,
the first stepped portion formed at the end surface of the substrate in a manner substantially parallel to the main surface of the substrate.
